(19) United States
(12) Patent Application Publication
(10) Pub. No.: US 2026/0367574 A1
(43) Pub. Date: Nov. 19, 2026

(54) ANNUAL CALENDAR MECHANISM OF A HOROLOGICAL MOVEMENT

(71) Applicant: BLANCPAIN SA, Le Brassus (CH)

(72) Inventor: Bernat MONFERRER, St-Prex (CH)

(73) Assignee: BLANCPAIN SA, Le Brassus (CH)

(21) Appl. No.: 19/655,942

(22) Filed: Apr. 23, 2026

(30) Foreign Application Priority Data
May 13, 2025 (EP) 25176193.8

(51) Int. Cl. G04B 19/253; G04B 19/24

(52) U.S. Cl. CPC G04B 19/2536; G04B 19/241

(57) ABSTRACT

An annual calendar mechanism of a horological movement, includes a date wheel (141) driven by the time train and an annual date mechanism including: a month cam driven in rotation by the date wheel, and including a periphery that distinguishes 31-day months from other months; an annual date feeler configured to sense information on the periphery of the month cam; and an annual date lever that advances the date wheel by one additional position at the end of each month having less than 31 days. The annual date mechanism includes a date cam superposed on the month cam and rotationally driven from the date wheel by a date cam gear train to make a complete turn in 31 days. The date cam has a single notch allowing the month cam to be sensed by the annual date feeler only once in a month.

### CROSS REFERENCE TO RELATED APPLICATIONS

This application claims priority to European Patent Application No. 25176193.8 filed May 13, 2025, the entire contents of which are incorporated herein by reference.

### TECHNICAL FIELD OF THE INVENTION

The field of the invention relates to annual calendar mechanisms incorporated in timepieces, for example annual calendar mechanisms displaying the date and the month.

The invention also relates to a horological movement comprising such an annual calendar mechanism.

The invention also relates to a timepiece, for example a wristwatch, comprising a horological movement comprising such a calendar mechanism.

### TECHNOLOGICAL BACKGROUND

Calendar mechanisms display one or more indications of temporal information in addition to the timekeeping information provided by the time train in the horological movement.

Conventionally, calendar mechanisms are additional mechanisms powered by the time train from the energy source in the horological movement. For example, calendar mechanisms can be date mechanisms, day-date mechanisms, annual date mechanisms, perpetual date mechanisms, etc.

The annual calendar mechanisms make it possible to take into account the different lengths of the months, and to automatically correct the display of the date when the current month has 30 days. Such an annual calendar mechanism has the advantage of being corrected only once a year in February.

To achieve this automatic correction of the date, it is known to use a month cam, to count the months, on which the different months of the year are programmed. Thus, the month cam presents raised sections defining the 31-day months and recessed sections, forming notches, defining the 30-day months, or vice versa. The month cam typically engages with a feeler that allows a change of one additional unit of the date for the 30-day months, so as to automatically change from day 30 to day 31 then from day 31 to day 1 of the following month, within the same daily cycle.

Typically, the month cam is driven in rotation at the end of each complete date cycle.

When the annual calendar mechanism presents a month display that is kinematically linked to the month cam, it therefore remains stationary during the complete date cycle from day 1 to day 31. Therefore, this type of display does not allow the user to know whether they are at the beginning or at the end of the current month.

Moreover, the various types of information shown on an annual calendar (most commonly the day, date and month) are usually indicated by specific displays or indicators that are separate from the time display organs. These various temporal indications of calendar information can be displayed by specific indicators, such as hands facing a dial, or by rotating discs that display the information through one or more apertures in the dial. As a result, such calendar mechanisms increase the number of indicators and cause visual overload on the dial.

In addition, the multiplication of specific indicators, or displays, for displaying the different temporal indications of calendar information increases the complexity of the horological movement. As a result, these calendar complications are often limited to expensive and complex timepieces.

Multiplying the specific indicators, or displays, for displaying the different temporal indications of calendar information also causes an increase in the thickness of the horological movement, which increases the final thickness of the timepiece.

Finally, these different indicators, or displays, of temporal indications of calendar information are typically driven in jumps so that the indicator aligns with a graduation or division of a dial. This type of jumping display is inaccurate because it does not allow the user to know whether they are at the beginning or at the end of the period displayed by the indicator.

Lastly, these jumping indicators, or displays, are energy inefficient and generate peaks of energy consumption during the jump that may momentarily disrupt the normal operation of the time train of the horological movement. Thus, the multiplication of the jumping indicators, or displays, may further disrupt the normal operation of the time train.

As a result, there is a need to improve the annual calendar mechanisms for prior art horological movements to meet at least one of the aforementioned problems.

In EP document 3327516 filed by the applicant, a seasonal display mechanism was proposed, including a seasonal display wheel driven once a day with an offset from the date display wheel. However, nothing in the document indicates how to use such a drive mechanism in an annual calendar mechanism, which includes an automatic date correction device depending on the current month.

### SUMMARY OF THE INVENTION

To this end, the invention proposes an annual calendar mechanism that can be driven by a time train in a horological movement, said annual calendar mechanism comprising:
a date wheel driven in jumps by the time train and carrying a date indicator configured to engage with a date graduation;
an annual calendar mechanism comprising:
   a rotating cam of the months driven by the date wheel, the month cam comprising a contoured periphery to distinguish the 31-day months from the other months;
   an annual date feeler configured to sense information on the periphery of the month cam;
   an annual date lever cooperating with the annual date feeler and configured to advance the date wheel by one additional position at the end of each month having less than 31 days.

The annual date mechanism further comprises a date cam that is coaxial and superposed on the month cam, said date cam being driven in rotation from the date wheel by a date cam gear train so as to make a complete turn in 31 days, said date cam comprising a periphery on which a single notch is provided, said notch allowing the month cam to be felt only once in the month by the annual date feeler.

Thanks to the annual calendar mechanism according to the invention, it is possible to drive the month cam with an indexing different from the annual calendar mechanisms of the prior art, in which the month cam is incremented by one step once a month at the end of the date cycle.

This is made possible by using the date cam that allows the month cam to be felt only on the 30^{th} day of the month in order to correct the date, if necessary, for the months having fewer than 31 days.

Thanks to the invention, it is therefore possible to drive a month display, in steps, kinematically linked to the month cam, with an indexing different from a monthly indexing.

Preferably, the month cam is rotated by jumps from the date wheel via a month cam gear train, the month cam gear train of the months having a gear ratio different from the date cam gear train.

Preferably, the month cam is driven by jumps by the date wheel so as to have an angular offset of 30°with respect to the date cam at each complete turn of the date cam.

Preferably, the month cam is driven with a reduction ratio relative to the date cam or with a multiplier ratio relative to the date cam.

Preferably, the month cam is driven with a reduction ratio of (x×12−1)/12 or with a multiplier ratio of (x×12+1)/12, with x being a positive integer other than 0.

Preferably, the month cam is driven with a reduction ratio of 11/12 or with a multiplier ratio of 13/12 with respect to the date cam.

Preferably, the annual calendar mechanism comprises a month display kinematically linked to the month cam and cooperating with the date hand to indicate the current month and the current period of the month.

Preferably, the annual calendar mechanism comprises a day display.

Preferably, the day display is a mobile disc driven in rotation by the time train, by jumps and in a dragging manner, the mobile disc cooperating with the date hand to indicate the current day and the period of the day.

Preferably, the annual calendar mechanism comprises a differential gear, driven by the time train, configured to drive the mobile disc of the days by jumps and in a dragging manner.

The invention also relates to a horological movement comprising a time train and an annual calendar mechanism, according to the invention, driven by the time train.

Preferably, the time train comprises a motion work wheel, said motion work wheel being kinematically linked to the annual calendar mechanism.

Preferably, the horological movement comprises a mechanism for quick correction of the date and/or the months.

The invention also relates to a timepiece, for example a wristwatch, comprising a horological movement according to the invention.

Advantageously, the annual calendar mechanism according to the invention makes it possible to display at least two different temporal indications of calendar information, and advantageously three different temporal indications of calendar information, related to a calendar by means of a single date indicator, for example of the hand type, and a movable month disc driven in a dragging and jumping manner, preferably in two different directions.

For example, the calendar mechanism according to the invention is a calendar mechanism displaying the date and the month, or alternatively the day, date and month.

### BRIEF DESCRIPTION OF THE FIGURES

The purposes, advantages and characteristics of the present invention will become apparent from the detailed description below in reference to the following figures:

FIG. 1 shows a schematic top view of a first exemplary embodiment of an annual calendar mechanism according to the invention, mounted on a plate or a bridge of a horological movement;

FIG. 2 shows a top view of the annual calendar mechanism illustrated in FIG. 1 isolated from the plate;

FIG. 3 shows a bottom view of the annual calendar mechanism illustrated in FIG. 2;

FIG. 4 illustrates a cross-sectional view along axis A-A of FIG. 2 of the annual calendar mechanism according to the invention.

FIG. 5 shows a perspective view of the annual calendar mechanism illustrated in FIG. 2;

FIG. 6 shows a first position of the date feeler sensing day 30 of a 31-day month on the month cam of the first exemplary embodiment of the annual calendar mechanism illustrated in FIG. 2.

FIG. 7 shows a second position of the date feeler sensing day 30 of a 30-day month on the month cam of the first exemplary embodiment of the annual calendar mechanism illustrated in FIG. 2.

FIG. 8 shows a detailed view of the month cam of the first exemplary embodiment of the annual calendar mechanism illustrated in FIG. 2;

FIG. 9 shows a detailed view of the date cam of the first exemplary embodiment of the annual calendar mechanism illustrated in FIG. 2.

FIG. 10 shows a timepiece comprising a horological movement equipped with the first exemplary embodiment of the calendar mechanism according to the invention.

FIG. 11 shows a timepiece comprising a horological movement equipped with a second exemplary embodiment of the calendar mechanism according to the invention.

In all of the figures, common elements have the same reference numbers unless otherwise specified.

### DETAILED DESCRIPTION OF THE INVENTION

The invention relates to an annual calendar mechanism of a horological movement that makes it possible to display at least one indication of calendar information relating to the date, and whose display of the date is corrected automatically at the end of a month having fewer than 31 days, such that such an annual calendar mechanism according to the invention requires only one manual correction per year by the user.

The invention will be described as part of a first exemplary embodiment in which the annual calendar mechanism is a mechanism indicating information relating to the date and information relating to the current month.

However, the invention, and in particular the annual date mechanism that will be described in this application, is applicable to any annual calendar mechanism displaying at least the date.

More specifically, the first exemplary embodiment of the annual calendar mechanism advantageously enables the current date and month to be displayed simultaneously by a single indicator, such as a hand.

However, the invention can also be applied in an annual calendar mechanism comprising a dedicated display for displaying the date and another dedicated display for displaying the current month.

Advantageously, the annual calendar mechanism according to the first exemplary embodiment makes it possible to display three different indications of information with a single indicator, for example a hand, such as the date, the month and the period of the current month. The invention can also be applied and adapted to the display of other temporal information linked to an annual calendar.

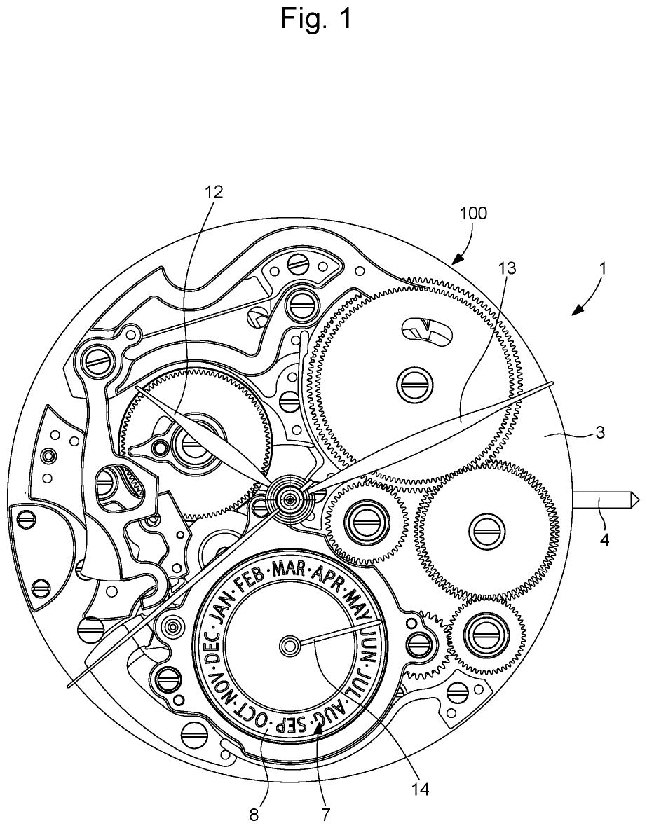

The first exemplary embodiment of an annual calendar mechanism according to the invention will be described with reference to FIGS. 1 to 10.

FIG. 1 schematically represents a top view of the first exemplary embodiment of the annual calendar mechanism 100 according to the invention mounted on a plate 3, or on a bridge, of a horological movement 1.

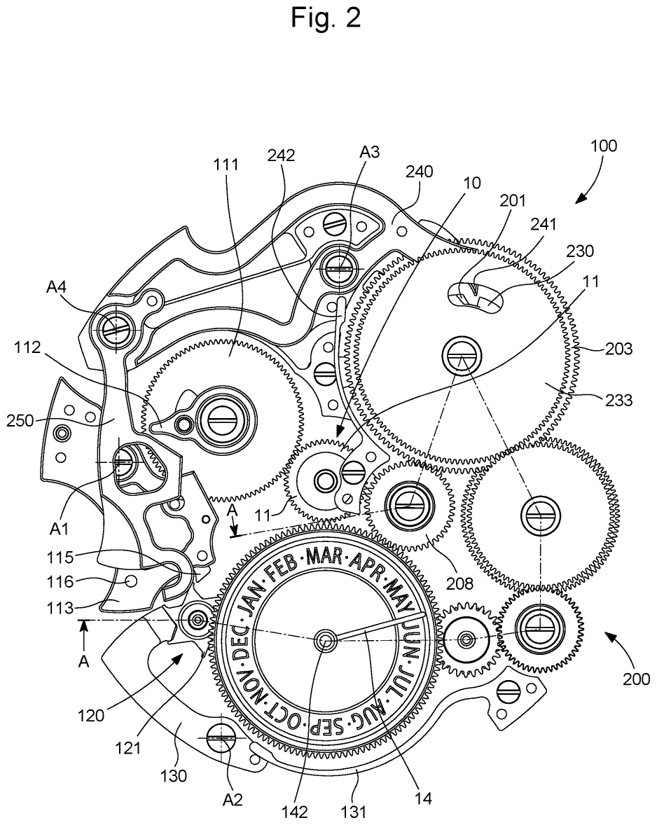

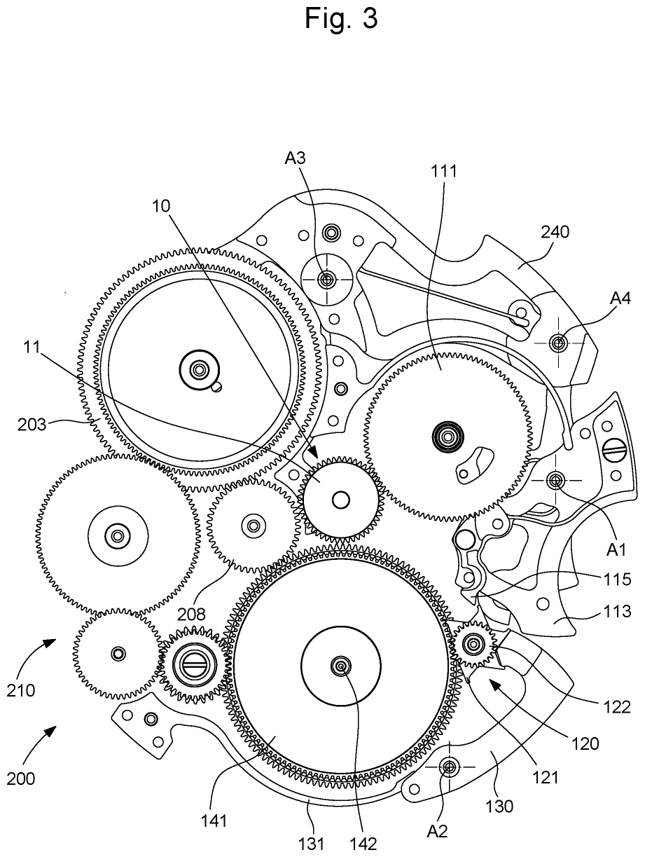

FIG. 2 illustrates more specifically the annual calendar mechanism 100 according to the invention isolated from the plate 3 as seen from above, and FIG. 3 illustrates this annual calendar mechanism 100 as seen from below.

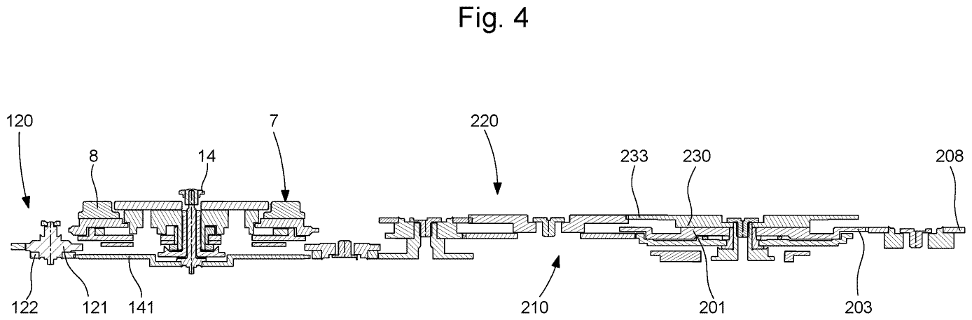

FIG. 4 shows a cross-sectional view, along the A-A axis, of the annual calendar mechanism 100 illustrated in FIG. 2.

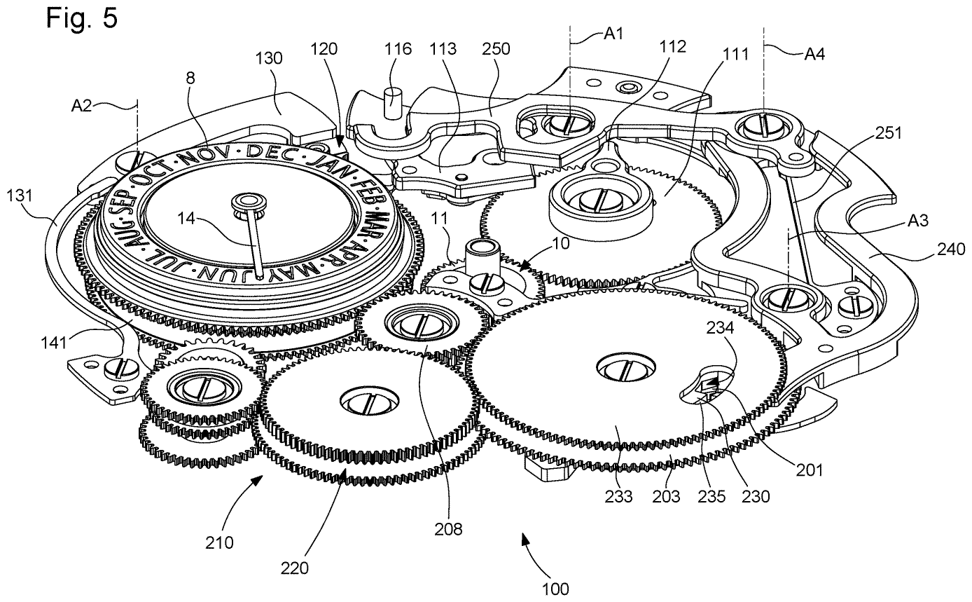

FIG. 5 shows a perspective view of the annual calendar mechanism 100 according to the invention.

With reference to FIGS. 1 to 5, the annual calendar mechanism 100 according to the invention is driven by a time train 10, partially shown in FIGS. 1 and 3, of the horological movement 1.

Typically, the time train 10 comprises a motion work wheel 11 distributing the hour and minute information to the respective indicators 12, 13 for indicating the hours and minutes while enabling their correction by a time-setting mechanism, partially shown by the winding stem 4 in FIG. 1.

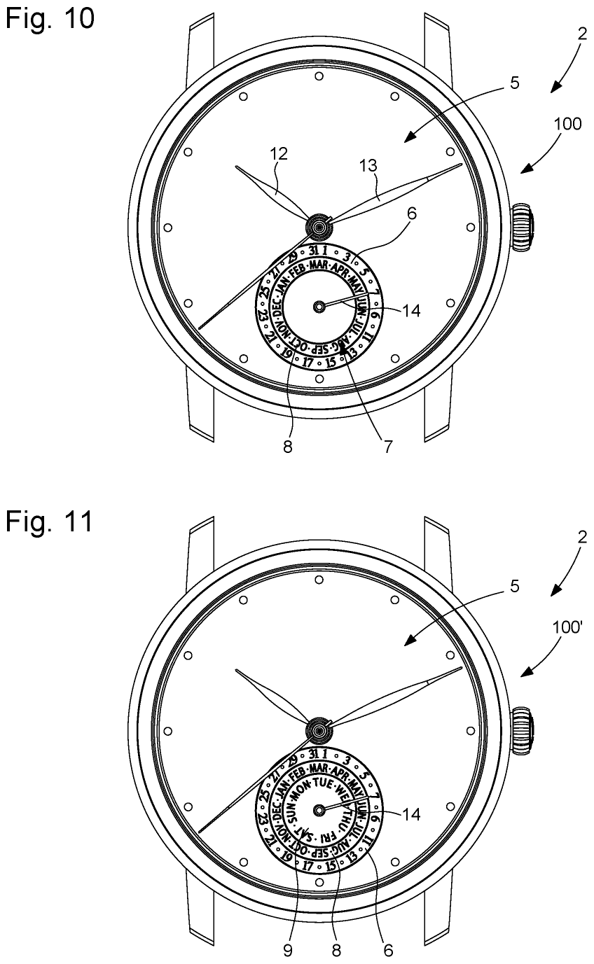

The annual calendar mechanism 100 according to the invention advantageously uses a single jumping indicator, for example a display hand 14, to indicate both the date, the current month and the period of the current month, as shown in particular in FIG. 10 which illustrates a timepiece 2 comprising the first example of the annual calendar mechanism 100.

In the exemplary embodiment shown, the date, current month and period of the month are displayed at 6 o'clock, but other arrangements on the dial 5 are possible without departing from the context of the invention.

To display the date and month, the display hand 14, hereinafter referred to as the date hand, engages facing a first fixed graduation 6 representing the dates (shown in FIG. 10), and with a second graduation for the months 7 carried by a mobile disc 8, rotationally movable coaxially with the display hand 14, the second graduation 7 showing the months of the year.

According to a variant embodiment, the indicator 14 can be in the form of a second mobile disc, rotationally mobile relative to the dial 5, with a single reference guide mark visible to the user, the second mobile disc being configured to engage facing the first fixed graduation 6 and facing the second graduation 7 to respectively display the current date and month.

With reference to FIGS. 2 to 5, the annual calendar mechanism 100 according to the invention comprises a drive wheel 111 kinematically linked to the time train 10 in the horological movement 1, and more specifically to the motion work wheel 11. For example, the drive wheel 111 is a 24-hour wheel rotated by the time train 10 so as to make one complete turn in 24 hours.

The drive wheel 111 carries a finger 112 configured to engage, with each turn of the drive wheel 111, with a lever 113, which in turn actuates a mobile 120.

In the exemplary embodiment described, the drive wheel 111 is a 24-hour wheel carrying a date finger 112 configured to engage, once a day, with a date lever 113, which in turn actuates a date mobile 120.

When actuated by the date finger 112, the date lever 113 pivots around its axis of rotation A1. The date lever 113 is subject to the action of a return spring (not shown) that returns the date lever 113 to its locked position when the latter is not restrained by the date finger 112.

The date lever 113 comprises a lever beak 115 configured to drive the date mobile 120 in jumps when the date lever 113 is actuated.

The lever beak 115 can have a certain angular play relative to the body of the date lever 113 and be subjected to a return spring, so as to provide a disengagement function and thereby prevent damage to the mechanism in the event of a quick correction of the date outside a desired time window, either via a push button or via a specific axial position of the winding stem 4.

The date mobile 120 comprises a 6-point date star 121 that is driven directly by the lever beak 115 once a day.

The date star 121 is indexed in position by a date jumper 130 that is rotationally mobile along the axis of rotation A2 and permanently controlled by a jumper spring 131.

The date star 121 advantageously features unidirectional toothing, meaning that the toothing has a profile that allows the date star 121 to rotate in only one direction relative to the date jumper 130. This means that the date star 121 cannot be rotated in the opposite direction to the normal drive.

The date mobile 120 also comprises a date pinion 122 that rotates along with the date star 121.

The date pinion 122 meshes with a date wheel 141 that carries the date hand 14 on its rotating arbor 142. The date hand 14 engages facing the fixed date graduation 6 located, for example, on a portion of the dial 5 of the timepiece 2 or on a fixed date disc.

Thus, as in conventional date mechanisms, the date hand 14 is driven in steps by the action of the date finger 112 carried by the drive wheel 111 acting on the date lever 113. In the illustrated exemplary embodiment, the date wheel 141 and the date hand 14 make a complete turn in 31 days and are driven in jumps of 1/31 of a turn.

By way of example, the date pinion 122 comprises 24 teeth and the date wheel 141 comprises 124 teeth, such that if the date lever 113 causes the date mobile 120 to jump by ⅙ of a turn, the date wheel 141 and the date hand 14 rotate by 1/31 of a turn.

The annual calendar mechanism 100 comprises an annual date mechanism 200 allowing for the automatic correction of the date when the current month has fewer than 31 days.

The annual date mechanism 200 is driven by the date wheel 141 and configured to advance the date wheel 141, and the associated date hand 14, one additional step (or position) at the end of each month of the year having fewer than 31 days.

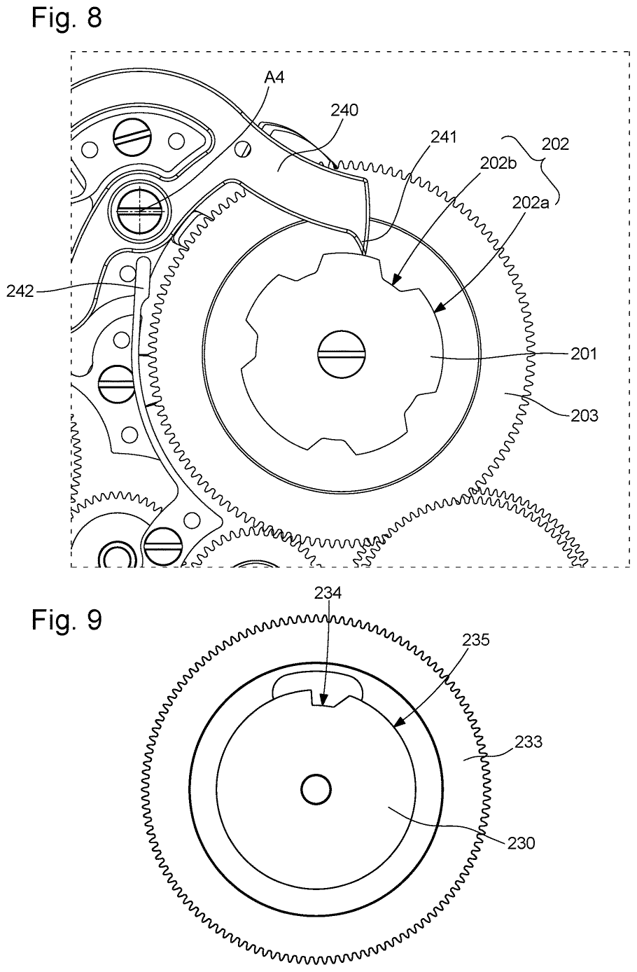

The annual date mechanism 200 comprises a month cam 201, also referred to as an annual cam, illustrated in more detail in FIG. 8, with a periphery 202 designed to represent months with 31 days and months with fewer than 31 days. Thus, the periphery 202 of the month cam 201 is divided into 12 equal angular sectors, each sector corresponding to one month of the year. For example, the seven 31-day months are represented by seven large-diameter raised sectors 202a, and the five months having fewer than 31 days are represented by five small-diameter recessed sectors 202b.

The month cam 201 is rotationally integral with a month wheel 203 which is driven in rotation from the date wheel 141 through a month cam gear train 210.

The month display of the annual calendar mechanism 100 is for example driven by the month cam 201, so that the month display is indexed in position with the month cam 201. Thus, in the illustrated exemplary embodiment, the month disc 8 is kinematically linked with the month wheel 203 via an intermediate wheel 208.

The annual date mechanism 200 comprises an annual date feeler 240 configured to sense the periphery 202 of the month cam 201. More precisely, the annual date feeler 240 comprises a beak 241 configured to sense the periphery 202 of the month cam 201, and more particularly the different sectors 202a, 202b of the periphery 202 depending on the angular position of the month cam 201.

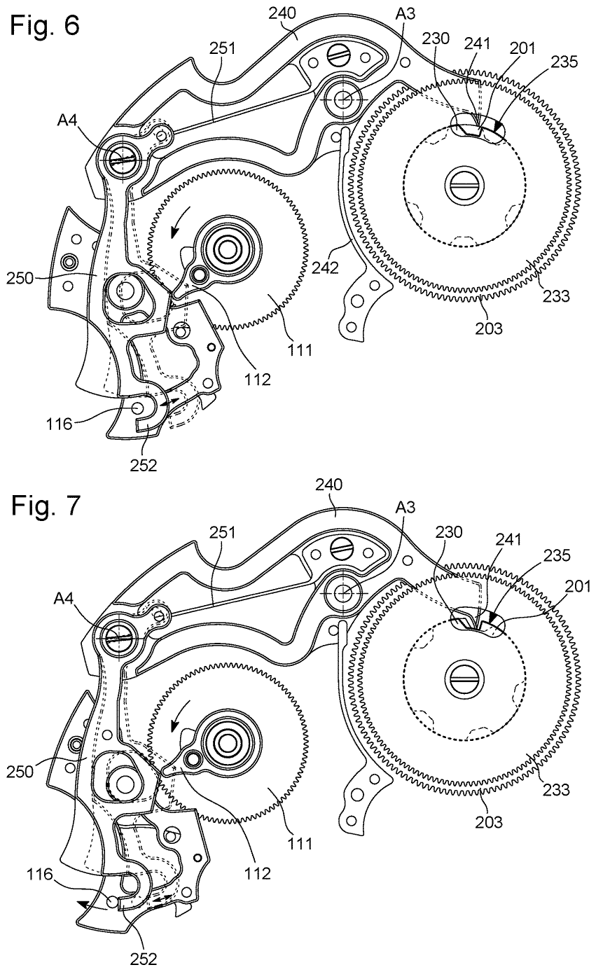

The annual date feeler 240 pivots in rotation around a rotation axis A3 and engages with a feeler spring 242 tending to position the beak 241 against the periphery 202 of the month cam 201 (i.e. either against a raised sector 202a or against a recessed sector 202b). Thus, depending on the position of the beak 241 on the periphery 202 of the month cam 201, the annual date feeler 240 may take two different angular positions, particularly represented in FIGS. 6 and 7.

The annual date feeler 240 engages with an annual date lever 250 pivot-mounted to the body of the annual date feeler 240 around a rotation axis A4, at an end opposite the beak 241.

The annual date lever 250 engages with a return spring 251 configured to maintain the annual date lever 250 in a reference position as long as a force is not exerted on the annual date lever 250, in particular by the date finger 112.

Changing the angular position of the annual date feeler 240 depending on the months sensed on the month cam 201 makes it possible to change the position, and the pivot point, of the annual date lever 250 with respect to the date lever 113.

When the annual date feeler 240 senses a raised sector 202a corresponding to a 31-day month, the annual date feeler 240 positions the annual date lever 250 in an inactive position (shown in FIG. 6). The inactive position of the annual date lever 250 corresponds to a position in which it cannot interact with the date lever 113.

In the exemplary embodiment described, in the inactive position of the annual date lever 250, the latter is always on the path of the date finger 112. On the other hand, even if the date finger 112 actuates the annual date lever 250 as it passes once a day, the pivoting thereof has no effect on the date lever 113. Indeed, in the inactive position of the annual date lever 250, it is not positioned in such a way that it can interact with the date lever 113.

Another solution would be to position the annual date lever 250 outside the circular path of the date finger 112, in this inactive position.

When the annual date feeler 240 senses a recessed sector 202b, corresponding to a month comprising fewer than 31 days, the annual date feeler 240 tilts into its second position, causing the annual date lever 250 to be in an active position (illustrated in FIG. 7). In this active position, the annual date lever 250 is positioned so as to be able to interact with the date lever 113, in the event of actuation of the annual date lever 250 by the date finger 112. For this purpose, it is noted that in the active position of the annual date lever 250, the end 252, opposite the pivot point A4, is positioned opposite a stop member 116 integral with the date lever 113.

Thus, in this active position, rotation of the date finger 112 first causes the annual date lever 250 to rotate about its axis of rotation A4 by exerting a force against the return spring 251. Rotation of the annual date lever 250 by the date finger 112 makes it possible to change, by one unit or step, the position of the date wheel 141 by interacting with the date lever 113 via the stop member 116.

Secondly, by continuing to rotate the drive wheel 111, the date finger 112 comes into contact with the date lever 113, advancing again the date wheel set 120 by one step, and therefore the date wheel 141 in a conventional manner.

Thus, in months with fewer than 31 days, the date wheel set 120 is driven in rotation twice in succession in less than 24 hours, that is to say in the same turn of the drive wheel 111, so as to go from day 30 to day 31 and then from day 31 to day 1 of the following month.

The annual date mechanism 200 also comprises a date cam 230 coaxial with and superposed on the month cam 201. The date cam 230 serves as a safety cam allowing the month cam 201 to be sensed by the annual date feeler 240 only once a month, and more particularly on day 30.

The date cam 230 is integral in rotation with a date cam wheel 233 which is driven in rotation from the date wheel 141 via a date cam gear train 220. The date cam gear train 220 is designed so that the date cam 230 completes a complete turn in 31 days, like the date wheel 141.

In the exemplary embodiment, the date cam gear train 220 is superposed on the month cam gear train 210, such that the wheels comprising the date cam gear train 220 can be superposed and share the same axis of rotation as the wheels comprising the month cam gear train 210, the wheels of a first gear train being rotationally independent of the wheels of a second gear train, which may be free or attached depending on requirements.

The date cam 230, shown from below in FIG. 9, comprises a periphery having a first sector 235 distal to the centre of rotation of the date cam 230 and a second sector 234 proximal to the centre of rotation, the second sector 234 forming a notch, or a recessed sector, relative to the first sector 235 with a larger diameter.

Preferably, the angular position of the date cam 230 is indexed with respect to the date wheel 141, such that the notch 234 is positioned opposite the beak 241 of the annual date feeler 240 when the date displays day 30.

The first sector 235 of the date cam 230 extends radially relative to the axis of rotation of the cams 201, 230, at least equivalently to the raised sectors 202a of the month cam 201, or the first sector 235 of the date cam 230 is radially aligned with the raised sectors 202a of the month cam 201.

Preferably, the first sector 235 of the periphery of the date cam 230 is radially farther from the axis of rotation than the large-diameter sectors 202a of the month cam 201, so as to ensure that the annual date feeler 240 is in contact only with the date cam 230 and not with the large-diameter sectors 202a of the month cam 201, as long as the date cam 230 is not in a predetermined angular position allowing the month cam 201 to be sensed.

Preferably, the second proximal sector 234 of the date cam 230 is radially closer to the axis of rotation than the recessed sectors 202b of the month cam 201, or radially aligned with the recessed sectors 202b of the month cam 201.

The beak 241 of the annual date feeler 240 is configured to be able to sense simultaneously the two levels of the cams 201, 230 axially superposed.

The date cam 230 makes it possible to block the sensing of the month cam 201 for a first period, for example for 30 days, and makes it possible to allow the sensing of the month cam 201 for a second period of shorter duration, for example for one day, on day 30 of the month.

Thus, through the use of the date cam 230, it is not necessary to index the month cam 201 monthly at the end of each month, as is the case with an annual calendar mechanism of the prior art.

According to the invention, the cam gear train for months 210 has a gear ratio different from the date cam gear train 220, such that the month cam 201 advantageously has an angular offset from the date cam 230 when it makes a complete turn in 31 days.

Preferably, the month cam 201 is driven in jumps by the date wheel 141 with an angular offset of 30°relative to the date cam 230 for one complete turn of the date cam 230, in other words, in 31 days.

The gear train of the month cam 210 has a reduction ratio or a multiplier ratio relative to the gear train of the date cam 220.

Preferably, the month cam 201 is driven with a reduction ratio of (x×12−1)/12 or with a multiplier ratio of (x×12+1)/12, with x being a positive integer other than 0.

For example, the month cam 201 is driven with a reduction ratio of 11/12 so that it makes 11 turns per year while the date cam 230 makes 12 turns per year.

Thus, in the first exemplary embodiment of the invention presented, for thirty consecutive days, or in other words for thirty consecutive steps of the date, the annual date feeler 240 is supported only on the first distal sector 325 of the date cam 230. And for one day, when the date cam 230 is in a predetermined angular position, that is, when the notch 234 is opposite the beak 241, the date cam 230 allows the month cam 201 to be sensed by the annual date feeler 240.

The horological movement 1 according to the invention may also comprise a rapid correction mechanism interacting with the annual date mechanism to correct the date indicator 14 and/or the month display 7,8. Such a rapid correction mechanism can be implemented by rotation of the winding stem 4, in a specific axial position. For example, for a quick correction of the months, the quick correction mechanism may interact with the month cam gear train 210 to drive the month cam 201, as well as the month display independently of the date, for example with steps corresponding to one month. For such a rapid correction, it is necessary to provide a disengagement or friction device according to the prior art between the date wheel 141 and the month cam 201.

### How the Annual Calendar Mechanism According to the Invention Works

The date wheel 141, and therefore the date hand 14, is driven by 1/31 of a turn per day by the driving wheel 111. To this end, the date finger 112 engages with the date lever 113, in turn driving the date wheel set 120 comprising the date star 121 indexed in a stable position at each step by the date jumper 130.

At each driving step of the date wheel 141, the date cam 230 is driven by a step corresponding to 1/31 of a turn via the date cam gear train 220.

At each driving step of the date wheel 141, the month cam 201 is advanced by one step with a reduction ratio of (x×12−1)/12 or with a multiplier ratio of (x×12+1)/12, with x being a positive integer other than 0, relative to the date wheel 141, by the month cam gear train 210.

By way of example, the month cam 201 is advanced by one step with a reduction ratio of 11/12 relative to the date wheel 141, such that, for every twelve turns of the date wheel 141 and the date cam 230, the month cam 201 makes 11 turns.

Between day 1 and day 29, the notch 234 of the date cam 230 superposed on the month cam 201 is not positioned opposite the beak 241 of the annual date feeler 240, which prevents the month cam 201 from being sensed. The annual date feeler 240 is therefore resting against the first sector 235 of the periphery 232 of the date cam 230, positioning the annual date feeler 240 and the annual date lever 250 in their inactive position. Thus, when the date finger 112 activates the annual date lever 250 once a day, it does not interact with the date lever 113. The date is therefore driven only once a day by the date finger 112 from day 1 to day 29.

On day 30, the date cam 230 arrives in an angular position in which the notch 234 lies opposite the beak 241 of the annual date feeler 240, thereby allowing the annual date feeler 240 to sense the periphery 202 of the month cam 201 under the action of the feeler spring 242.

Two scenarios may then arise. When the current month is a month of 31 days, the annual date feeler 240 then senses a raised sector 202a of the month cam 201. In this position, the annual date feeler 240 and the annual date lever 250 remain in their inactive position, or in a position very close to their inactive position if the radial dimensions of the peripheries of cams 201, 230 are slightly different. This situation is shown in FIG. 6.

As shown in FIG. 6, when the date finger 112 rotates the annual date lever 250 at the end of the 30^{th} day, it does not interact with the date lever 113. The date is therefore driven only once by the date lever 113 in a conventional manner, thus moving from day 30 to day 31. The passage from day 31 to day 1 of the following month takes place identically to the other days of the month between day 1 and day 29 described previously, because as soon as day 31 is reached, the notch 234 is angularly offset by one step relative to the beak 241, thus positioning the first sector 235 of the periphery of the date cam 230 opposite the beak 241, so that the month cam 201 is then no longer sensed by the beak 241 of the annual date feeler 240.

When the current month is a month of less than 31 days, the annual date feeler 240 then senses a recessed sector 202b of the month cam 201, modifying the angular position of the annual date feeler 240 and of the annual date lever 250 about the axis of rotation A3, so as to position the annual date lever 250 in an active position, in which the end 252 is positioned opposite the stop member 116 of the date lever 113. As shown in FIG. 7, when the passage of the date finger 112 activates the annual date lever 250, it interacts with the date lever 113 via the stop member 116, causing an additional pivoting of the date lever 113 in less than 24 hours, and causing the date wheel 141 to be advanced by one additional step. Thus, in this active position of the annual date lever 250, the date is advanced twice in less than 24 hours by the date finger 112, which allows the transition from day 30 to day 31 and then from day 31 to day 1 of the following month.

### Second Exemplary Embodiment

In a second exemplary embodiment, the annual calendar mechanism according to the invention makes it possible to indicate the date, day and month.

Preferably, the second exemplary embodiment of the annual calendar mechanism 100′ enables the current date and month to be displayed simultaneously by a single indicator 14, such as a hand, as shown in FIG. 11.

Advantageously, the second exemplary embodiment of the annual calendar mechanism 100′ according to the invention makes it possible to display five different indications of calendar information with a single indicator, for example a hand, such as the date, day, period of the current day (24-hour display), the month as well as the period of the current month.

This second exemplary embodiment of the invention is identical to the first exemplary embodiment described with reference to FIGS. 1 to 10, with the exception of the characteristics that will be described subsequently.

To display, in addition, the days, the annual calendar mechanism 100′ has a day disc 9 marked with the days of the week.

The annual calendar mechanism 100′ comprises the means necessary to rotate the day disc 9 from the time train 10.

By way of example, the day disc 9 is driven in a dragging manner from the time train 10, for example via the drive wheel 111 throughout the day, and is corrected by a jump by the date wheel set 120 once a day when the date changes.

For example, the annual calendar mechanism 100′ may comprise a differential in which:
a first input is kinematically linked to the dragging drive of the drive wheel 111;
a second input is kinematically linked to the jumping drive of the date wheel 141, for example via the date wheel set 120 which includes an additional pinion;
an output kinematically linked to the day disc 9.

The operation of such an annual calendar mechanism 100′ according to the invention is as follows: in the normal operating regime of the horological movement 1, i.e. outside the moment when the date hand 14 changes position, occurring for example at midnight, the drive wheel 111 is driven in rotation by the time train 10, so as to make one turn per day, for example in the clockwise direction. The drive wheel 111 drives, counterclockwise and in a dragging manner throughout the day, an intermediate wheel set which in turn drives clockwise the first input wheel of the differential. The second input wheel of the differential being locked in rotation by the date wheel set 120 indexed in position by the date jumper 130, the day disc 9 is driven in rotation in the counterclockwise direction during the day.

In the exemplary embodiment, the day disc 9 is driven in a dragging manner over the course of a day so as to make 1/7 of a turn per day in the opposite direction from the direction in which the date hand 14 advances.

Thus, during the day, the date hand 14, which remains fixed, makes it possible to provide, opposite the day disc 9 which is moving and rotating in the opposite direction, additional information to the user on the period of the current day, equivalent to a 24-hour display or a day/night indicator.

When the date changes, for example at midnight, in a time range close to midnight, or in another predetermined time range, the date finger 112 actuates the date lever 113 which drives the date wheel set 120 one step in the counterclockwise direction, in the illustrated exemplary embodiment. The date wheel set 120 drives the date wheel 141 and the date hand 14 by 1/31 of a turn in the clockwise direction. Simultaneously, the date wheel set 120 drives the second input wheel of the differential 160 clockwise, driving the day disc 9 clockwise by 1/31 of a turn, identically to the advance of the date hand 14, so as to position the day disc 9 in a predetermined position opposite the new position of the date hand 14 at the start of each day.

The invention also relates to a horological movement 1 comprising a calendar mechanism 100 according to the invention.

The invention also relates to a timepiece 2, such as a wristwatch comprising a horological movement 1 comprising a calendar mechanism 100, 100′ as described above with reference to FIGS. 1 to 9.

1. An annual calendar mechanism that can be driven by a time train in a horological movement, said annual calendar mechanism comprising:
a date wheel driven in jumps by the time train and carrying a date indicator configured to engage facing a date graduation; and
an annual date mechanism comprising:
a month cam driven in rotation by the date wheel, the month cam comprising a periphery designed to distinguish the 31-day months from the other months;
an annual date feeler configured to sense information on the periphery of the month cam; and
an annual date lever cooperating with the annual date feeler and configured to advance the date wheel by one additional position at the end of each month having less than 31 days;
wherein the annual date mechanism comprises a date cam coaxial and superposed on the month cam, said date cam being rotationally driven from the date wheel by a date cam gear train so as to make a complete turn in 31 days, said date cam comprising a periphery on which a single notch is provided, said notch allowing the month cam to be sensed by the annual date feeler only once in the month.

2. The annual calendar mechanism according to claim 1, wherein said month cam is rotated in steps from the date wheel via a month cam gear train, the month cam gear train having a different gear ratio than the date cam gear train.

3. The annual calendar mechanism according to claim 2, wherein the month cam is driven in steps by the date wheel so as to have an angular offset of 30°with respect to the date cam at each complete turn of the date cam.

4. The annual calendar mechanism according to claim 3, wherein the month cam is driven with a reduction ratio relative to the date cam or with a multiplier ratio relative to the date cam.

5. The annual calendar mechanism according to claim 4, wherein the month cam is driven with a reduction ratio of (x×12−1)/12 or with a multiplier ratio of (x×12+1)/12, with x being a positive integer other than 0.

6. The annual calendar mechanism according to claim 5, wherein the month cam is driven with a reduction ratio of 11/12 or with a multiplier ratio of 13/12 relative to the date cam.

7. The annual calendar mechanism according to claim 1, wherein the annual calendar mechanism comprises a month display kinematically linked to the month cam and cooperating with the date hand to indicate the current month and the period of the current month.

8. The annual calendar mechanism according to claim 1, wherein the annual calendar mechanism comprises a day display.

9. The annual calendar mechanism according to claim 8, wherein the day display is a mobile disc driven rotationally by the time train by jumps and in a dragging manner, the mobile disc cooperating with the date hand to indicate the current day and the period of the day.

10. The annual calendar mechanism according to claim 9, wherein the annual calendar mechanism comprises a differential gear, driven by the time train, configured to drive the movable day disc by jumps and in a dragging manner.

11. A horological movement comprising a time train and an annual calendar mechanism, according to claim 1, driven by the time train.

12. The horological movement according to claim 11, wherein the time train comprises a motion work wheel, said motion work wheel being kinematically linked to the annual calendar mechanism.

13. The horological movement according to claim 11, wherein the horological movement comprises a quick-correction mechanism for at least one indication of the annual calendar mechanism.

14. The horological movement according to claim 13, wherein the quick-correction mechanism makes it possible to correct the date indicator and/or the month display.

15. A timepiece comprising the horological movement according to claim 11.
